(19) United States
(12) Patent Application Publication
(10) Pub. No.: US 2015/0117154 A1
(43) Pub. Date: Apr. 30, 2015

(54) APPARATUS FOR TRANSMITTING POSITIONING SIGNAL AND METHOD FOR INDOOR POSITIONING USING THE SAME

(71) Applicant: Electronics and Telecommunications Research Institute, Daejeon (KR)

(72) Inventor: Sung Hoon KWAK, Daegu (KR)

(21) Appl. No.: 14/525,703

(22) Filed: Oct. 28, 2014

(30) Foreign Application Priority Data
Oct. 29, 2013 (KR) 10-2013-0129383

(51) Int. Cl. G01S 1/76; H04B 11/00

(52) U.S. Cl. CPC G01S 1/76; H04B 11/00
USPC 367/118; 367/137

(57) ABSTRACT

Disclosed are an apparatus for transmitting positioning signals, a method for indoor positioning based on the positioning signals, and an apparatus for performing the same. The method comprises receiving a plurality of acoustic or ultrasonic waves; measuring strengths of the received plurality of acoustic or ultrasonic waves; identifying frequencies of the received plurality of acoustic waves or ultrasonic waves; and performing positioning based on the measured strengths and the identified frequencies of the received plurality of acoustic waves or ultrasonic waves. Accordingly, positioning can be easily performed without additional separate hardware configurations, and positioning accuracy suitable for indoor positioning services can be achieved.

### CLAIM FOR PRIORITY

This application claims priority to and the benefit of Korean Patent Application No. 10-2013-0129383 filed on Oct. 29, 2013 in the Korean Intellectual Property Office (KIPO), the entire contents of which are hereby incorporated by reference.

### BACKGROUND

1. Technical Field

Example embodiments of the present invention relate in general to an indoor positioning technique, and more specifically, to apparatuses for transmitting positioning signals using acoustic or ultrasonic waves, methods for indoor positioning using the same, and apparatuses performing the same.

2. Related Art

Due to a rapid advancement of radio communication technologies, various location-based services using the radio communication technologies are being utilized. The location-based service (LBS) identifies user's current position and provides various additional information and services based on the identified current position.

Currently, appearance of various smart devices having functions such as Global Positioning System (GPS), terrestrial magnetism sensor, camera, radio frequency identification (RFID), etc. diversifies the location based services.

Since conventional positioning techniques usually use GPS and mobile communication networks to identify user's current position, they are usually being used for outdoor services. However, in indoor environments where GPS signals cannot be received, the position of users cannot be measured. Also, since more accurate positioning is necessary for indoor applications, GPS and mobile communication networks are not suitable for the indoor services.

Although various indoor positioning systems using RFID, infrared ray, ultrasonic wave, Ultra Wide Band (UWB), Wi-Fi Access Point (AP), Bluetooth, various embedded sensors, etc. have been developed as indoor positioning technologies, each of the technologies has its unique shortcoming which cannot be overcome.

The technique, which performs indoor positioning for user by measuring signal strengths of Wi-Fi Access points and generating a radio map based on the measured signal strengths, has advantages that it can use already-installed access points and its initial cost of construction is relatively cheap. However, it has shortcomings that regular updates of the radio map are necessary and costs of the updates are expensive.

Also, although the indoor positioning techniques using camera, gyro sensor, terrestrial magnetism sensor, etc. have advantages that initial construction of infrastructure is not necessary, they have shortcomings that errors of positioning accumulate as the positioning service use time increases.

Meanwhile, although the indoor positioning techniques utilizing UWB, Bluetooth, etc. have advantages that they have better positioning accuracy, they have shortcomings that costs of initial infrastructure construction are relatively higher.

Especially, the conventional indoor positioning systems using ultrasonic wave, which have high relevancy to the present invention, comprise ultrasonic wave transmitters and receivers, and perform indoor positioning based on propagation time and reception time of the ultrasonic waves. Therefore, they have very high positioning accuracy. However, they have shortcomings that users should carry additional transmitter and receiver as well as their smart devices. Also, the ultrasonic wave transmitters and receivers for indoor positioning need to be provided with electric power. Also, since it is preferable that the transmitters and receivers are installed in a ceiling of a building, the installation costs of the transmitters and receivers are quite high. As described above, the conventional indoor positioning techniques using ultrasonic wave have problems that they need separate devices as well as the smart devices and they need expensive initial infrastructure construction.

### SUMMARY

Accordingly, example embodiments of the present invention are provided to substantially obviate one or more problems due to limitations and disadvantages of the related art.

Example embodiments of the present invention, as indoor positioning techniques for positioning users having smart devices, provide apparatuses for transmitting indoor positioning signals, which can decrease initial infrastructure construction costs and provide positioning accuracy suitable for indoor positioning services.

Example embodiments of the present invention provide methods for indoor positioning, which can perform the indoor positioning by using the positioning signals transmitted from the apparatuses for transmitting positioning signals.

In some example embodiment, an apparatus for transmitting positioning signals may comprise a compressed air generating part which generates compressed air; an air delivery part which is connected to the compressed air generating part and delivers the compressed air generated in the compressed air generating part, wherein a plurality of air venting holes are formed in the air delivery part; and a plurality of positioning signal generating parts which are fastened to the plurality of air venting holes and generate signals having different frequencies by using air vented through the plurality of air venting holes.

Here, the compressed air generating part may provide the plurality of positioning signal generating parts with compressed air having a constant pressure.

Here, the plurality of positioning signal generating parts may generate acoustic or ultrasonic waves having different frequencies.

Here, each of the plurality of positioning signal generating parts may be implemented with a pipe having a labium, and depths of the labia or diameters of the pipes of the positioning signal generating parts may be configured differently to each other.

In other example embodiment, an indoor positioning apparatus may comprise a receiving part which receives a plurality of acoustic or ultrasonic waves having different frequencies; a control part which performs positioning based on strengths and frequencies of the plurality of acoustic or ultrasonic waves; and a display part which displays a result of the positioning according to control of the control part.

Here, the indoor positioning apparatus may further comprise a storage part storing position information of acoustic or ultrasonic wave generating parts which generate the plurality of acoustic or ultrasonic waves.

Here, the indoor positioning apparatus may further comprise a communication part which communicates with an external positioning server according to control of the control part, wherein the control part obtains position information of acoustic or ultrasonic wave generating parts which generate the plurality of acoustic or ultrasonic waves from the external positioning server through the communication part.

Here, the control part may select a predetermined number of acoustic or ultrasonic waves among the plurality of acoustic or ultrasonic waves in descending order of reception strengths, identify frequencies of the selected acoustic or ultrasonic waves, obtain position information of acoustic or ultrasonic wave generating parts which generate acoustic or ultrasonic waves having the identified frequencies, and measure a position of the indoor positioning apparatus based on the obtained position information.

In still other example embodiment, a method for indoor positioning using positioning signals may comprise receiving a plurality of acoustic or ultrasonic waves; measuring strengths of the received plurality of acoustic or ultrasonic waves; identifying frequencies of the received plurality of acoustic or ultrasonic waves; and performing positioning based on the measured strengths and the identified frequencies of the received plurality of acoustic or ultrasonic waves.

Here, the measuring strengths may include selecting a predetermined number of acoustic or ultrasonic waves among the received plurality of acoustic or ultrasonic waves in descending order of reception strengths.

Here, in the identifying frequencies, frequencies of the predetermined number of acoustic or ultrasonic waves may be respectively identified.

Here, the performing positioning may include obtaining position information of a plurality of positioning signal generating parts which transmit acoustic or ultrasonic waves having the identified frequencies; and performing triangulation or location fingerprint algorithm based on the position information and reception strengths of the acoustic or ultrasonic waves having the identified frequencies.

Also, the method may further comprise receiving the position information of the plurality of positioning signal generating parts from an external positioning server and storing the position information. Also, in the obtaining position information, position of each of positioning signal generating parts which transmit acoustic or ultrasonic waves having the identified frequencies may be obtained based on the stored position information.

Also, the obtaining position information may include includes querying the position information of the plurality of positioning signal generating parts by using the identified frequencies to an external positioning server; and receiving the position information of the plurality of positioning signal generating parts from the external positioning server.

According to the above-described positioning signal transmission apparatuses and the above-described indoor positioning methods based on the positioning signals, the apparatuses may comprise at least one compressed air generation part, at least one air delivery part, and a plurality of positioning signal generating parts, and may transmit acoustic waves or ultrasonic waves by using them, whereby initial installation costs can be decreased. Also, indoor positioning accuracy can be enhanced by using acoustic waves and ultrasonic waves for the indoor positioning.

Also, the apparatuses for performing indoor positioning by receiving acoustic waves or ultrasonic waves transmitted from the above apparatuses for transmitting positioning signals can be implemented by using conventional smart devices such as smart phones, smart pad, etc. That is, a microphone equipped in the smart device can be utilized to receive acoustic waves or ultrasonic waves, and an application executing an algorithm for analyzing the received signals and determining user's position based on the analysis can be executed in the smart device. Accordingly, positioning can be easily performed without additional separate hardware configurations, and positioning accuracy suitable for indoor positioning services can be achieved.

### BRIEF DESCRIPTION OF DRAWINGS

Example embodiments of the present invention will become more apparent by describing in detail example embodiments of the present invention with reference to the accompanying drawings, in which:

FIGS. 1 to 3 are views to explain configurations of a positioning signal transmission apparatus according to the present invention and installation environments for the same;

FIG. 4 is a sectional view to illustrate a detail configuration of a positioning signal transmission apparatus according to the present invention;

FIG. 5 is a conceptual view to explain an indoor positioning method according to the present invention;

FIG. 6 is a block diagram to illustrate a configuration of an indoor positioning apparatus according to the present invention;

FIG. 7 is a flow chart to explain an indoor positioning method according to the present invention; and

FIG. 8 is a conceptual view to explain a positioning procedure according to the indoor positioning method of the present invention.

### DESCRIPTION OF EXAMPLE EMBODIMENTS

Example embodiments of the present invention are described below in sufficient detail to enable those of ordinary skill in the art to embody and practice the present invention. It is important to understand that the present invention may be embodied in many alternate forms and should not be construed as limited to the example embodiments set forth herein.

Accordingly, while the invention can be modified in various ways and take on various alternative forms, specific embodiments thereof are shown in the drawings and described in detail below as examples. There is no intent to limit the invention to the particular forms disclosed. On the contrary, the invention is to cover all modifications, equivalents, and alternatives falling within the spirit and scope of the appended claims.

The terminology used herein to describe embodiments of the invention is not intended to limit the scope of the invention. The articles “a,” “an,” and “the” are singular in that they have a single referent, however the use of the singular form in the present document should not preclude the presence of more than one referent. In other words, elements of the invention referred to in the singular may number one or more, unless the context clearly indicates otherwise. It will be further understood that the terms “comprises,” “comprising,” “includes,” and/or “including,” when used herein, specify the presence of stated features, items, steps, operations, elements, and/or components, but do not preclude the presence or addition of one or more other features, items, steps, operations, elements, components, and/or groups thereof.

Unless otherwise defined, all terms (including technical and scientific terms) used herein are to be interpreted as is customary in the art to which this invention belongs. It will be further understood that terms in common usage should also be interpreted as is customary in the relevant art and not in an idealized or overly formal sense unless expressly so defined herein.

Hereinafter, embodiments of the present invention will be described in detail with reference to the appended drawings. In the following description, for easy understanding, like numbers refer to like elements throughout the description of the figures, and the same elements will not be described further.

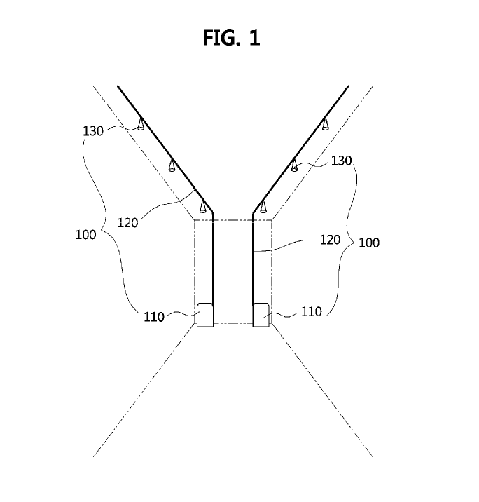

FIGS. 1 to 3 are views to explain configurations of a positioning signal transmission apparatus according to the present invention and installation environments for the same.

Hereinafter, referring to FIGS. 1 to 3, the configurations of the positioning signal transmission apparatus according to the present invention and the environment to which the apparatus is applied will be explained in further detail.

The positioning signal transmission apparatus 100 according to the present invention may comprise a compressed air generating part 110, an air delivery part 120, and at least one positioning signal generating part 130.

The compressed air generating part 110 may perform a function of generating compressed air. For example, it may be configured with an air pump, an air compressor, etc. As shown in FIG. 1, there may be a plurality of compressed air generating parts in the apparatus 100.

Also, if the compressed air generating part 110 is configured with at least one air compressor, the compressed air generating part 110 may include an air pump, a compressed air tank, and a motor. Alternatively, if the compressed air generating part 110 is configured with an air pump which does not include a compressed air tank, the apparatus 100 may further include a separate compressed air tank for providing compressed air with a constant pressure.

When the compressed air generating part 110 is configured with an air compressor, the air compressor inhales air in the atmosphere, compresses the inhaled air, and stores the compressed air in the compressed air tank. The air stored in the compressed air tank may be discharged to external with a predetermined pressure. For this, the air compressor may have separate air pressure control means and discharging means which can discharge the compressed air.

However, the compressed air generating part 110 is not restricted to the air pump or the air compressor. Example embodiments of the present invention may include various compressed air generating parts which can generate compressed air and provide the compressed air with a constant pressure.

The compressed air generated in the compressed air generating part 110 may be provided to the air delivery part 120 connected through an outlet (not depicted) equipped in the compressed air generating part 110.

Meanwhile, when the compressed air generating part 110 is configured to operate with electric power, it may be installed in a position which is suitable for being provided with electric power. Alternatively, when it is difficult to be provided with electric power, the compressed air generating part 110 may be configured to operate based on fuel or battery. In these cases, the position in which the compressed air generating part 110 is installed is not restricted to a specific position or environment.

The air delivery part 120 may be configured with at least one cylindrical tube, at least one pipe, etc., and its one end may be fastened to the compressed air generating part 110 so that the air provided from the compressed air generating part 110 can flow through the tube or the pipe.

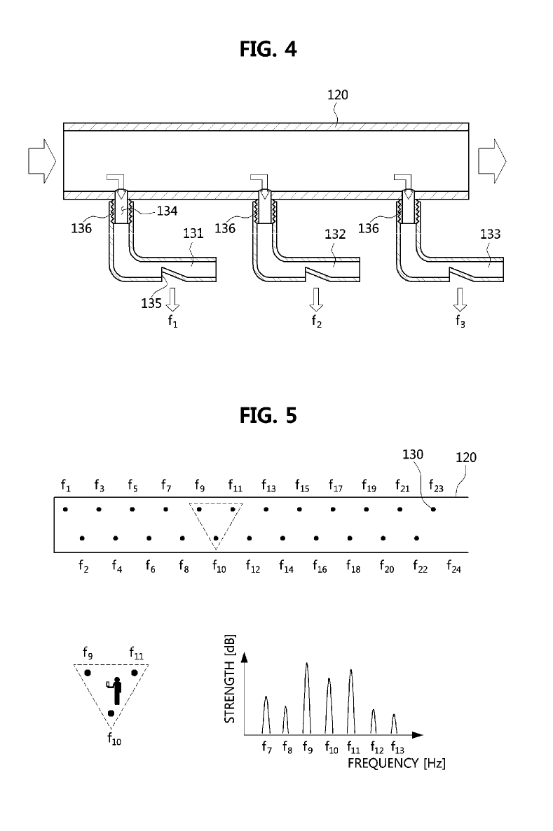

Also, a plurality of air venting holes (134 in FIG. 4), through which the compressed air can be discharged, may be formed in the air delivery part 120, and each of the plurality of the air venting holes 134 may be fastened to respective positioning signal generating parts 130.

Also, the air delivery part 120 may have various forms according to its installation environments. That is, according to indoor structure or user's moving routes, the air delivery part 120 may be installed in a curved line form or a straight line form.

Also, the installation form of the air delivery part 120, the number of air venting holes 134 formed in the air delivery part 120, and distances between the air venting holes 134 may be determined according to a desired indoor positioning accuracy.

Each of the positioning signal generation parts 130 may be configured in a tubular form having a labium (135 of FIG. 4). Further, it may generate an acoustic or ultrasonic wave as a positioning signal by using the air outputted through the air venting hole to which it is fastened.

Also, depths of the labia or diameters of the tubes of positioning signal generating parts 130 may be configured differently so that each of the positioning signal generating parts can generate an acoustic or ultrasonic wave having different frequency.

For example, the plurality of the positioning signal generating parts 130 may be implemented as pipes which can generate acoustic or ultrasonic waves by using compressed air. Also, the frequencies of the acoustic waves or the ultrasonic waves generated by the pipes can be configured differently by adjusting depths of labia formed in the pipes, the diameter of the pipes, or the lengths of the pipes.

In the following example embodiments according to the present invention, it is assumed that acoustic waves and ultrasonic waves are transmitted as positioning signals. In addition, the positioning signal generating part 130 may also be referred to as an acoustic or ultrasonic wave generating part. The acoustic waves or ultrasonic waves generated by the positioning signal generating part 130 may be assumed to be inaudible frequencies (e.g. frequencies beyond 20,000 Hz).

Hereinafter, referring to FIGS. 1 to 3, installation environments for the positioning signal transmission apparatus 100 according to the present invention will be explained in detail.

As shown in FIG. 1, a plurality of positioning signal transmission apparatuses according to the present invention may be installed in an indoor space.

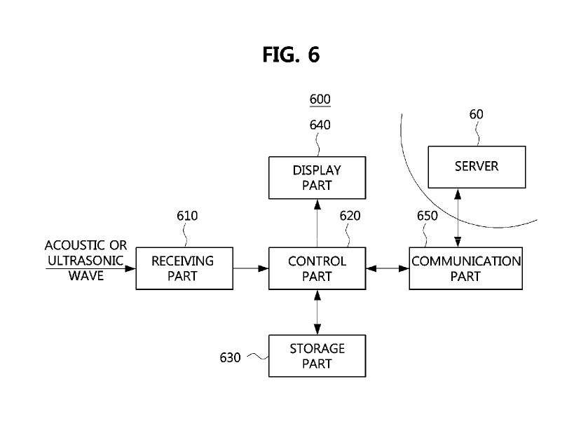

Specifically, for the positioning signal transmission apparatus, the air delivery part 120 connected to the compressed air generating part 110 may be installed on a ceiling of the indoor space. Also, acoustic or ultrasonic wave generating parts 130 may be installed in the air delivery part 120 with constant distances, and thus compressed air provided from the compressed air generating part 110 can flow through the air delivery part 120 and can be provided to the acoustic or ultrasonic wave generating parts 130 with a constant pressure so that acoustic waves or ultrasonic waves having predetermined frequencies can be generated. Here, strengths of the generated acoustic waves and ultrasonic waves are constant since pressure of the compressed air provided to the acoustic or ultrasonic wave generating parts 130 is constant. Therefore, the acoustic waves or ultrasonic waves transmitted from the parts 130 are received by indoor positioning apparatus (600 of FIG. 6) with different strengths according to position of the indoor positioning apparatus. In the present invention, the reception strengths or frequencies of the acoustic waves or ultrasonic waves are used for performing positioning.

The compressed air generating part 110 may be installed in a position having convenience of power supply or a position having easiness of power supply.

Also, the air delivery part 120 may be installed on the ceiling of the indoor space through a wall of the indoor space. For example, the air delivery part 120 may be installed in positions of the ceiling corresponding to a moving route of the user in order to enhance positioning accuracy. Since the indoor positioning is performed based on strengths and frequencies of the plurality of acoustic waves and ultrasonic waves which are generated from the acoustic or ultrasonic wave generating parts 130 and received by the indoor positioning apparatus, if an obstacle exists between the parts 130 and the indoor positioning apparatus 600, the reception strengths of the acoustic waves and ultrasonic waves can be affected. Thus, it is preferable that line of sight (LOS) is retained between the acoustic or ultrasonic wave generating parts 130 and the indoor positioning apparatus 600 in order to enhance positioning accuracy. In this reason, in the above example embodiments according to the present invention, the acoustic or ultrasonic wave generating parts 130 may be installed on the ceiling which is easy to secure LOS.

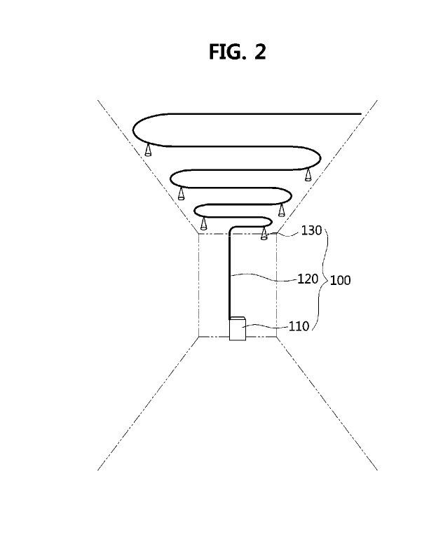

Alternatively, as shown in FIG. 2, only one positioning signal transmission apparatus 100 may be installed in the indoor space. For example, if accurate indoor positioning is possible by using only one positioning signal transmission apparatus due to small indoor space, only one positioning signal transmission apparatus may be installed differently to the case illustrated in FIG. 1.

Further, in case that only one positioning signal transmission apparatus 100 is installed in the indoor space as shown in FIG. 2, the air delivery part 120 may be installed in zigzag form on the ceiling of the indoor space.

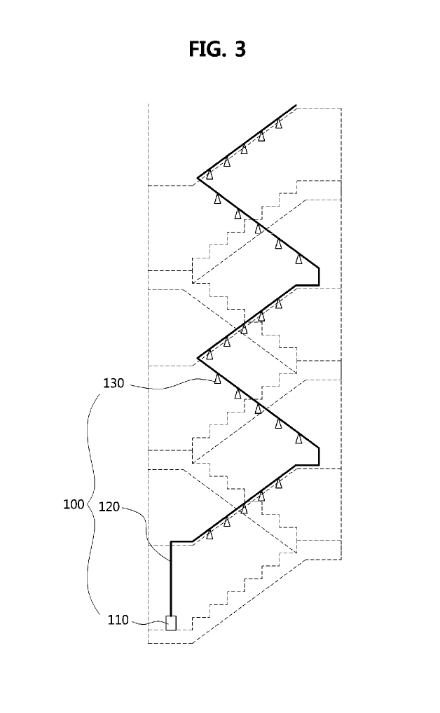

Alternatively, as shown in FIG. 3, the positioning signal transmission apparatus 100 according to the present invention may be installed in various places, to which the user can move, such as stairs of building, inclined space, vertical indoor structure, etc.

For example, the air delivery part 120 may be fastened to the compressed air generating part 110 which can output compressed air to the air delivery part 120. The air delivery part 120 may be installed along bottoms of the stairs, and the acoustic or ultrasonic wave generating parts 130 which are fastened to the air delivery part 120 may be installed to have spacing predetermined in accordance with the length or width of the steps.

FIG. 4 is a sectional view to illustrate a detail configuration of a positioning signal transmission apparatus according to the present invention.

Referring to FIG. 4, the configuration of the positioning signal transmission apparatus according to the present invention will be explained in further detail.

The air delivery part 120 may be configured with at least one cylindrical tube or pipe. Also, a plurality of air venting holes 134, which can output the air flowing through the tube or pipe, may be formed in the air delivery part 120 with predetermined constant distances.

A plurality of acoustic or ultrasonic wave generating parts 130 may be fastened to the air delivery part 120 through the plurality of air venting holes 134 formed in the air delivery part 120.

Here, at least one fastening element 136 may be used for fastening the acoustic or ultrasonic wave generating parts 130 to the air delivery part 120. One end of the fastening element 136 may be fixedly installed in the air venting hole 134. For this, screw threads may be formed in the outer peripheral edge of the fastening element 136, and threaded rods may be formed in the inner peripheral edge of the acoustic or ultrasonic wave generating parts 130. Thus, the air delivery part 120 may be fastened to the plurality of acoustic or ultrasonic wave generating parts 130 through the screw coupling.

In addition to the above-described fastening structure, the air delivery part 120 may be fastened to the plurality of acoustic or ultrasonic wave generating parts 130 in a number of known fastening structures. For example, one end of the fastening element 136 may be directly installed to the corresponding air venting hole by using sealing material for preventing leakage of compressed air.

The air flowing through the interior of the air delivery part 120 may be outputted through a first acoustic or ultrasonic wave generating part 131, a second acoustic or ultrasonic wave generating part 132, and a third acoustic or ultrasonic wave generating part 133 via the plurality of air venting holes 134. Then, each of the acoustic or ultrasonic wave generating parts may generate an acoustic or ultrasonic wave having different frequency which is used as a positioning signal.

Each of the acoustic or ultrasonic wave generating parts may be configured in a tubular form (e.g. a pipe) having a labium 135. Also, depth of the labium or diameter of the tube of each acoustic or ultrasonic wave generating part may be configured differently so that each of acoustic or ultrasonic wave generating parts can generate an acoustic wave or ultrasonic wave having different frequency.

For example, as shown in FIG. 4, the first acoustic or ultrasonic wave generating part 131 may generate a first frequency f₁, and the second acoustic or ultrasonic wave generating part 132 may generate a second frequency f₂, and the third acoustic or ultrasonic wave generating part 133 may generate a second frequency f₃.

Also, frequencies generated from the plurality of the acoustic or ultrasonic wave generating parts may be configured to have a constant difference according to a position of each of the acoustic or ultrasonic wave generating parts. For example, the difference between the first frequency f₁ and the second frequency f₂ may be configured to be the same with the difference between the second frequency f₂ and the third frequency f₃.

Also, the installation distances between the acoustic or ultrasonic wave generating parts may be adjusted according to a desired positioning accuracy. For example, the installation distances may be determined to be values optimized for the desired positioning accuracy through repetitive experiments. Thus, the acoustic or ultrasonic wave generating parts may be installed in the air delivery part 120 based on the determined installation distances.

FIG. 5 is a conceptual view to explain an indoor positioning method according to the present invention.

Referring to FIG. 5, the indoor positioning method according to the present invention, in which the indoor positioning apparatus 600 performs positioning based on acoustic waves or ultrasonic waves having different frequencies.

The positioning signal transmission apparatus 100 may transmit acoustic or ultrasonic waves having a plurality of different frequencies (e.g. f₁, f₂, f₃, . . . , f₂₄), and the indoor positioning apparatus 600 may receive the acoustic or ultrasonic waves having different frequencies from the plurality of acoustic or ultrasonic wave generating parts.

The indoor positioning apparatus 600 may select the predetermined number of acoustic or ultrasonic waves among the received acoustic or ultrasonic waves in the descending order of reception strengths.

For example, as shown in the strength analysis graph for frequencies illustrated in FIG. 5, the indoor positioning apparatus 600 may select the ninth frequency f₉, the tenth frequency f₁₀, and the eleventh frequency f₁₁ as three signals having the largest reception strengths. Then, the indoor positioning apparatus 600 may obtain position information of the acoustic or ultrasonic wave generating parts which transmitted the selected three waves. The indoor positioning apparatus 600 may measure its current position by performing triangulation based on the obtained positions of the three acoustic or ultrasonic wave generating parts.

Here, the position information of the acoustic or ultrasonic wave generating parts may be obtained from a storage part 630 existing in the indoor positioning apparatus 600 or from an external positioning server 660. Thus, the current position of the indoor positioning apparatus 600 may be measured based on the obtained position information of the acoustic or ultrasonic wave generating parts.

In addition, in cases of the stairs of the building, the inclined space, or the vertical indoor structure illustrated in FIG. 3, the indoor positioning apparatus 600 may be configured to perform positioning related to elevation by further utilizing elevation information of each of the acoustic or ultrasonic wave generating parts.

FIG. 6 is a block diagram to illustrate a configuration of an indoor positioning apparatus according to the present invention.

Referring to FIG. 6, a configuration of the indoor positioning apparatus 600 will be explained in further detail.

The apparatus 600 may comprise an acoustic or ultrasonic wave receiving part 610, a control part 620, a storage part 630, a display part 640, and a communication part 650.

The acoustic or ultrasonic receiving part 610 may receive a plurality of acoustic or ultrasonic waves having different frequencies, and convert the received plurality of acoustic or ultrasonic waves into electric signals. Here, the acoustic or ultrasonic receiving part 610 may be actually implemented with a microphone which can receive acoustic or ultrasonic waves.

The control part 620 may actually be implemented with at least one processor which can process instructions and data. The control part 620 may be provided with the electric signals corresponding to the plurality of acoustic or ultrasonic waves from the receiving part 610, and determine reception strengths of the plurality of acoustic or ultrasonic waves based on the corresponding electric signals.

Also, the control part 620 may select the predetermined number of acoustic or ultrasonic waves among the received plurality of acoustic or ultrasonic waves in descending order, identify frequencies of the selected waves, and obtain position information of the acoustic or ultrasonic wave generating parts which generate acoustic or ultrasonic waves having the identified frequencies. Here, the control part 620 may obtain the position information from the storage part 630. Alternatively, the control part 620 may obtain the position information from an external indoor positioning server 660 by transmitting information on the identified frequencies to the indoor positioning server 660 and receiving the position information in response to the information on the identified frequencies.

The storage part 630 may be implemented with at least one non-volatile memory device. Here, the storage part 630 may store positioning-related information used for measuring the position of the indoor positioning apparatus 600, and the positioning-related information may include position information of the plurality of acoustic or ultrasonic wave generating parts installed in the indoor space and information on frequencies generated by the plurality of acoustic or ultrasonic wave generating parts. Also, the position of each of the acoustic or ultrasonic wave generating parts is mapped to the frequency of the wave generated by each of the acoustic or ultrasonic wave generating parts.

The display part 640 may actually be implemented with display elements such as liquid crystal display (LCD), organic light emitting diodes (OLED), etc., and displays the positioning result of the indoor positioning apparatus 600 for the user.

The communication part 650 may actually be implemented with at least one communication interface which can perform wired or wireless communications. The communication part 650 may receive the positioning-related information from the external indoor positioning server 660, and transmit the result of the positioning performed in the control part 620 to the external positioning server 660.

The indoor positioning apparatus 600 may be a portable terminal, which includes the above-described components, such as a cellular phone, a smart phone, a pad-type terminal, a multimedia player, etc.

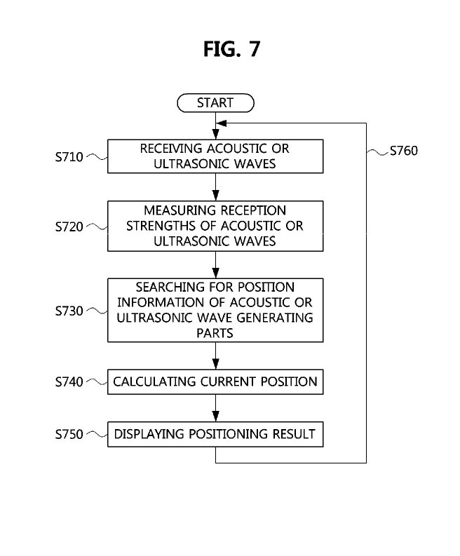

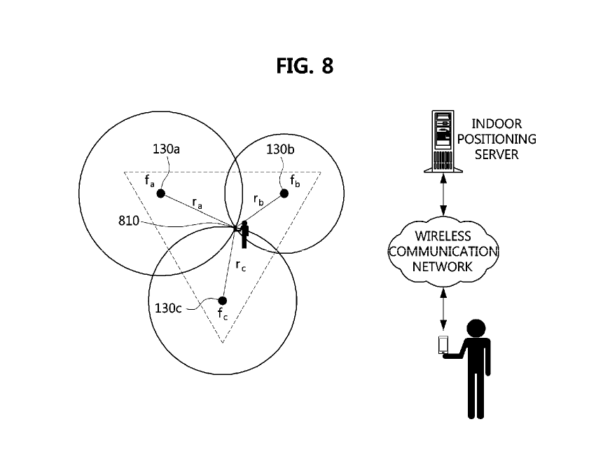

FIG. 7 is a flow chart to explain an indoor positioning method according to the present invention.

The indoor positioning method illustrated in FIG. 7 may be performed by the indoor positioning apparatus 600 which uses acoustic or ultrasonic waves as positioning signals.

Referring to FIG. 7, the indoor positioning apparatus 600 may receive a plurality of acoustic or ultrasonic waves having different frequencies transmitted from the plurality of acoustic or ultrasonic wave generating parts 130 (S710).

Then, the indoor positioning apparatus 600 may measure reception strengths of the received plurality of acoustic or ultrasonic waves (S720). Here, the indoor positioning apparatus 600 may select the predetermined number of acoustic or ultrasonic waves among the received plurality of acoustic or ultrasonic waves in descending order of the reception strengths, and then identify frequencies of the selected acoustic or ultrasonic waves.

Then, the indoor positioning apparatus 600 may obtain position information of acoustic or ultrasonic wave generating parts which generate the selected waves having the identified frequencies (S730). Here, the indoor positioning apparatus 600 may obtain the position information from the storage part 630, or obtain the position information from the external positioning server 660 by transmitting information on the identified frequencies to the positioning server 660 and receiving the position information in response to the information on the identified frequencies.

As described above, after obtaining the position information of the selected acoustic or ultrasonic wave generating parts 130, the indoor positioning apparatus 600 may calculate a current position of the indoor positioning apparatus 600 based on the obtained position information (S740).

Then, the indoor positioning apparatus 600 may display the calculated position as a positioning result (S750). Here, the indoor positioning apparatus 600 may display the positioning result (i.e. the current position of the indoor positioning apparatus 600) in a map as combined with information of a Geographic Information System (GIS).

In addition, the indoor positioning apparatus 600 may repetitively perform the steps S710 to S750 while the user carrying the indoor positioning apparatus 600 moves or until the indoor positioning apparatus 600 is deactivated (S760).

FIG. 8 is a conceptual view to explain a positioning procedure according to the indoor positioning method of the present invention.

As shown in FIG. 8, it is assumed that the user carrying the indoor positioning apparatus 600 is located in a specific position 810 of an indoor space.

At the specific position 810, the indoor positioning apparatus 600 may receive a plurality of acoustic or ultrasonic waves having different frequencies from a plurality of acoustic or ultrasonic wave generating parts 130, select the predetermined number (e.g. at least three) of acoustic or ultrasonic waves among the received plurality of acoustic or ultrasonic waves in descending order of the reception strengths, and identify frequencies (e.g. fa, fb, and fc) of the selected acoustic or ultrasonic waves.

Then, the indoor positioning apparatus 600 may obtain position information of acoustic or ultrasonic wave generating parts which generate the selected waves having the identified frequencies from the external positioning server 660 or from the storage part 630 of the indoor positioning apparatus 600.

Also, since strength of acoustic or ultrasonic wave is inversely proportional to the square of a reception distance of the acoustic or ultrasonic wave, a distance between each acoustic or ultrasonic wave generating part and the position 810 may be derived based on the strength of the acoustic or ultrasonic wave received from the corresponding acoustic or ultrasonic wave generating part. Therefore, the indoor positioning apparatus 600 may measure the current position (i.e. 810) by using triangulation based on the at least three derived distance values.

Here, the indoor positioning apparatus 600 may measure the current position by utilizing a location fingerprint method based on the derived values in addition to the triangulation.

If the indoor positioning apparatus 600 has a wireless communication function, it may transmit and receive position information of the plurality of acoustic or ultrasonic wave generating parts installed in the indoor space and additional information related to them with the external positioning server 660 by using a wireless communication network. The above additional information may include an indoor electronic map data of a building, a coordinate of the current position, etc.

The wireless communication network may include, for example, second generation mobile communication networks such as Global System for Mobile communication (GSM), Code Division Multiple Access (CDMA), etc., a mobile internet such as Wireless Fidelity (Wi-Fi), third generation mobile communication networks such as Wideband Code Division Multiple Access (WCDMA), CDMA2000, etc., and fourth generation mobile communication networks such as Long Term Evolution (LTE), LTE-Advanced, etc.

If the indoor positioning apparatus 600 does not have a wireless communication function or cannot access the wireless communication network, the storage part 630 may store position information of the plurality of acoustic or ultrasonic wave generating parts installed in the indoor space and additional information related to them.

While the example embodiments of the present invention and their advantages have been described in detail, it should be understood that various changes, substitutions and alterations may be made herein without departing from the scope of the invention.

What is claimed is:

1. An apparatus for transmitting positioning signals, the apparatus comprising:
a compressed air generating part which generates compressed air;
an air delivery part which is connected to the compressed air generating part and delivers the compressed air generated in the compressed air generating part, wherein a plurality of air venting holes are formed in the air delivery part; and
a plurality of positioning signal generating parts which are fastened to the plurality of air venting holes and generate signals having different frequencies by using air vented through the plurality of air venting holes.

2. The apparatus of claim 1, wherein the compressed air generating part provides the plurality of positioning signal generating parts with compressed air having a constant pressure.

3. The apparatus of claim 1, wherein the plurality of positioning signal generating parts generate acoustic or ultrasonic waves having different frequencies.

4. The apparatus of claim 1, wherein each of the plurality of positioning signal generating parts is implemented with a pipe having a labium, and depths of the labia or diameters of the pipes of the positioning signal generating parts are configured differently to each other.

5. An indoor positioning apparatus comprising:
a receiving part which receives a plurality of acoustic or ultrasonic waves having different frequencies;
a control part which performs positioning based on strengths and frequencies of the plurality of acoustic or ultrasonic waves; and
a display part which displays a result of the positioning according to control of the control part.

6. The apparatus of claim 5, further comprising a storage part storing position information of acoustic or ultrasonic wave generating parts which generate the plurality of acoustic or ultrasonic waves.

7. The apparatus of claim 5, further comprising a communication part which communicates with an external positioning server according to control of the control part, wherein the control part obtains position information of acoustic or ultrasonic wave generating parts which generate the plurality of acoustic or ultrasonic waves from the external positioning server through the communication part.

8. The apparatus of claim 5, wherein the control part selects a predetermined number of acoustic or ultrasonic waves among the plurality of acoustic or ultrasonic waves in descending order of reception strengths, identifies frequencies of the selected acoustic or ultrasonic waves, obtains position information of acoustic or ultrasonic wave generating parts which generate acoustic or ultrasonic waves having the identified frequencies, and measures a position of the indoor positioning apparatus based on the obtained position information.

9. A method for indoor positioning using positioning signals, the method comprising:
receiving a plurality of acoustic or ultrasonic waves;
measuring strengths of the received plurality of acoustic or ultrasonic waves;
identifying frequencies of the received plurality of acoustic or ultrasonic waves; and
performing positioning based on the measured strengths and the identified frequencies of the received plurality of acoustic or ultrasonic waves.

10. The method of claim 9, wherein the measuring strengths includes selecting a predetermined number of acoustic or ultrasonic waves among the received plurality of acoustic or ultrasonic waves in descending order of reception strengths.

11. The method of claim 9, wherein, in the identifying frequencies, frequencies of the predetermined number of acoustic or ultrasonic waves are respectively identified.

12. The method of claim 9, wherein the performing positioning includes:
obtaining position information of a plurality of positioning signal generating parts which transmit acoustic or ultrasonic waves having the identified frequencies; and
performing triangulation or location fingerprint algorithm based on the position information and reception strengths of the acoustic or ultrasonic waves having the identified frequencies.

13. The method of claim 12, further comprising receiving the position information of the plurality of positioning signal generating parts from an external positioning server and storing the position information,
wherein, in the obtaining position information, position of each of positioning signal generating parts which transmit acoustic or ultrasonic waves having the identified frequencies is obtained based on the stored position information.

14. The method of claim 12, wherein the obtaining position information includes:
querying the position information of the plurality of positioning signal generating parts by using the identified frequencies to an external positioning server; and
receiving the position information of the plurality of positioning signal generating parts from the external positioning server.
